(19) United States
(12) Patent Application Publication
(10) Pub. No.: US 2017/0297932 A1
(43) Pub. Date: Oct. 19, 2017

(54) METHOD OF REMEDIATING GROUNDWATER

(71) Applicant: PHILLIPS 66 COMPANY, Houston, TX (US)

(72) Inventors: Vrajesh Mehta, Bartlesville, OK (US); J. Bryant Pollock, Owassi, OK (US); Michael W. Page, Collinsville, OK (US); Sriram Satya, Bartlesville, OK (US)

(73) Assignee: PHILLIPS 66 COMPANY, Houston, TX (US)

(21) Appl. No.: 15/484,558

(22) Filed: Apr. 11, 2017

Related U.S. Application Data
(60) Provisional application No. 62/322,568, filed on Apr. 14, 2016.

(51) Int. Cl. C02F 1/72; B09C 1/00; C02F 101/32; C02F 103/06

(52) U.S. Cl. CPC C02F 1/722; C02F 1/725; B09C 1/002; C02F 2103/06; C02F 2101/322

(57) ABSTRACT

A method of remediating groundwater by injection a first aqueous solution and then a second aqueous solution into a well situated within the area of the groundwater to be remediated. The first aqueous solution comprises an iron ligand while the second aqueous solution comprises an oxidizing agent. It is envisioned that the ppm ratio of the iron ligand to oxidizing agent ranges from about 0.0005 to about 0.1.

### CROSS-REFERENCE TO RELATED APPLICATIONS

This application is a non-provisional application which claims the benefit of and priority to U.S. Provisional Application Ser. No. 62/322,568 filed Apr. 14, 2016, entitled “Method of Remediating Groundwater,” which is hereby incorporated by reference in its entirety.

### STATEMENT REGARDING FEDERALLY SPONSORED RESEARCH OR DEVELOPMENT

None.

### FIELD OF THE INVENTION

This invention relates to a method of remediating groundwater.

### BACKGROUND OF THE INVENTION

The Safe Water Drinking Act sets maximum contaminant levels for groundwater.

Examples of volatile organic compounds and semi-volatile organic compounds of concern can include trichloroethylene, vinyl chloride, tetrachloroethylene, methylene chloride, 1,2-dichloroethane, 1,1,1-trichloroethane, carbon tetrachloride, chloroform, chlorobenzenes, benzene, toluene, xylene, ethyl benzene, ethylene dibromide, methyl tertiary butyl ether, 2,4-dimethylphenol, 2-methylphenol, and 3- and 4-methylphenol, polyaromatic hydrocarbons, polychlorobiphenyls, phthalates, 1,4-dioxane, nitrosodimethyl amine, and methyl tertbutyl ether. Any groundwater remediation method should meet and/or exceed the maximum contaminant level set in the Safe Water Drinking Act. For example, treated water with total phenolic compound concentrations below 10 ppm should meet and/or exceed maximum contaminant levels.

There are a variety of techniques that have been used to remediate groundwater that have various degrees of effectiveness. Groundwater remediation typically involves injecting chemicals or other substances into the groundwater in different locations. The injected chemicals or other substances react with contaminates in the groundwater to eliminate them, to break them down into less harmful substances, and/or to otherwise neutralize them.

For example U.S. Pat. No. 5,741,427 discloses the possibility of using a Fenton-like reaction for treating contaminates by combining a ligand donor with a metal catalyst in the molar ratio range from about 0.5 to 1.5:1.

There exists a need for a simplified method of injecting solutions into groundwater to remediate groundwater.

### BRIEF SUMMARY OF THE DISCLOSURE

A method of remediating groundwater by injecting a first aqueous solution and then a second aqueous solution into a well situated within the area of the groundwater to be remediated. The first aqueous solution comprises an iron ligand, while the second aqueous solution comprises an oxidizing agent. It is envisioned that the ppm ratio of the iron ligand to oxidizing agent ranges from about 0.0005 to about 0.1.

A method of remediating contaminated groundwater consisting essentially of a first aqueous solution and a second aqueous solution into a well situated within the area of the groundwater to be remediated. The first aqueous solution comprises an iron tetra-amido macrocyclic ligand, while the second aqueous solution comprises a hydrogen peroxide.

A method of remediating contaminated groundwater by administrating a first series of injections followed by a second series of injections different than the first series of injection into a well situated within the area of the groundwater to be remediated. In this method, the first series of injections comprises a first aqueous solution and a second aqueous solution. The first aqueous solution comprises an iron tetra-amido macrocyclic ligand while the second aqueous solution comprises a hydrogen peroxide. It is envisioned that the ppm ratio of the iron tetra-amido macrocyclic ligand to hydrogen peroxide ranges from about 0.0005 to about 0.1.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts the amount of phenols removed after analyzing samples.

FIG. 2 depicts a flow system design.

FIG. 3 depicts the results from a flow system test.

FIG. 4 depicts the results from a flow system test.

FIG. 5 depicts the results from a flow system test.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

A method of remediating groundwater by injection a first aqueous solution and then a second aqueous solution into a well situated within the area of the groundwater to be remediated. The first aqueous solution comprises an iron ligand while the second aqueous solution comprises an oxidizing agent. It is envisioned that the ppm ratio of the iron ligand to oxidizing agent ranges from about 0.0005 to about 0.1.

The first aqueous solution can be an iron ligand such as iron tetra-amido macrocyclic ligand. In one embodiment the solid iron tetra-amido macrocyclic ligand is mixed with water onsite to produce an aqueous solution of iron tetra-amido macrocyclic ligand. It is envisioned that the first aqueous solution injected can be any volume needed to remediate the groundwater, such as from about 800 gallons to about 1,200 gallons. Accordingly, the ppm of iron tetra-amido macrocyclic ligand in the first aqueous solution can range from 0.001 to 1,000 ppm.

The second aqueous solution can be an oxidizing agent such as hydrogen peroxide, calcium peroxide, persulfates, sodium peroxide, and permanganates such as potassium permanganate and the like.

One of the aspects of the inventions can be both the volume ratio and the ppm ratio between the first aqueous solution and the second aqueous solution. It is envisioned that the volume ratio of the injection of the first aqueous solution to the second aqueous solution can be any volume ratio needed to remediate the groundwater, such as 0.8:1.0, 1:1, 1.0:0.8 or any range in between. It is also envisioned that the ppm ratio of the first aqueous solution to the second aqueous solution can be from about 0.0005 to about 0.1, from about 0.0001 to about 0.05 or any range in between.

It has been established that the ratios of the first aqueous solution and the second aqueous solution can be critical to this method and unexpected results occur relative to previously described remediation methods. By carefully managing the ratios, the current method can be injected into the groundwater as one constant flowing injection. In one example, immediately after the injection of the first aqueous solution, the second aqueous solution can flow into the well.

Generally, the injection method can be any means of introducing the aqueous solutions into the groundwater. This may include injection using pumps, blowers, compressors, tanks, tanks of compressed gas, a compressed gas tank (tanks of compressed gas and compressed gas tanks include compressed gas cylinders) after a blower or compressor and a geoprobe rig, hand-held injection rods that in part use the force of the injection slurry to advance the injection probe into the subsurface (applicable to shallower depths), use of wells, galleries, trenches, or horizontal wells and borings to introduce the injected material into the groundwater.

The speed in which the aqueous iron tetra-amido macrocyclic solution and the aqueous hydrogen peroxide solution are injected into the well can vary based on the migration speed of the groundwater. Generally, the injection pressures can range from approximately ten pounds per square inch (10 psi) up to approximately one thousand pounds per square inch (1,000 psi). Under one particular embodiment the injection rate of the injections occurs at a rate faster than the migration of the groundwater. The height of the treated area within the groundwater can range from about 5 feet in height to about 25 feet in height or even greater than 10 feet, 15 feet or even 30 feet in height. The width of the treated area within the groundwater can range from about 5 feet in width to about 20 feet in width or even greater than 8 feet, 12.5 feet or even 25 feet in width.

In one embodiment, the aqueous solutions that are injected into the groundwater can be comprising, consisting of or consisting essentially of the iron ligand and the oxidizing agent. For example, it is envisioned that in one embodiment no additional chemicals or no remediating chemicals are part of the injection method. It is theorized that by eliminating unnecessary chemicals such as surfactants, sorbents and pH modifiers the current method is economically more efficient than other methods currently employed.

The groundwater to be remediated in this method can be at depths greater than 10, 25, 50, 75, 100, 125, 150, 175, even 200 feet underground. At this depth the composition of the groundwater can be unique as it often times no longer flows as liquid water but instead as slurry.

In one embodiment, the method can incorporate the injection of water in addition to the iron ligand and the oxidizing agent. The injection of water can be done once, twice or three times during different stages of the method. The different stages of the method in which the injection of water can occur can be independently selected from injecting prior to the iron ligand, in between the injections of the iron ligand and the oxidizing agent, or after the injection of the oxidizing agent.

The current method can be used to remediate volatile organic compounds in groundwater. Types of volatile organic compounds that can be remediated include: m-cresol, p-cresol, o-cresol, xylenol, phenol, ethyltoluene, 1,2-dichloropropylene, ethanol, dichlorosilane, methyl tert-butyl ether, mercuric acetate, xylene, triethoxysilane, acrylyl chloride, hexafluoroacetone, n-propyl nitrate, tetraethyltin, methyl mercury, vinyl bromide, isobutyl chloroformate, 1,3-dichloropropylene, 2,4-dimethylphenol, 2-methylphenol, 3- and 4-methylphenol, tert-butyl acetate, methyl isopropyl ketone, ketene, nickel acetate, acetyl bromide, ethyl acetate, acetic anhydride, isopropyl acetate, isopropyl ether and other known volatile organic compounds. The removal of different types of volatile organic compounds such as phenol can range from 75%, 80%, 85%, 90%, 95% even 99% remediated.

In one embodiment the current method can be utilized to remediate a specific chemical in the groundwater such as phenols (2,4-dimethylphenol, 2-methylphenol, and 3- and 4-methylphenol). By remediating a specific chemical the current method can be ensured to lower the maximum contaminant level of that specific chemical in the groundwater.

In an alternative embodiment, the method of remediating a specific chemical can be combined with other another method of remediating a specific chemical in a method of sequential injections to remediate specific types of contaminates.

The following examples of certain embodiments of the invention are given. Each example is provided by way of explanation of the invention, one of many embodiments of the invention, and the following examples should not be read to limit, or define, the scope of the invention.

### Test 1:

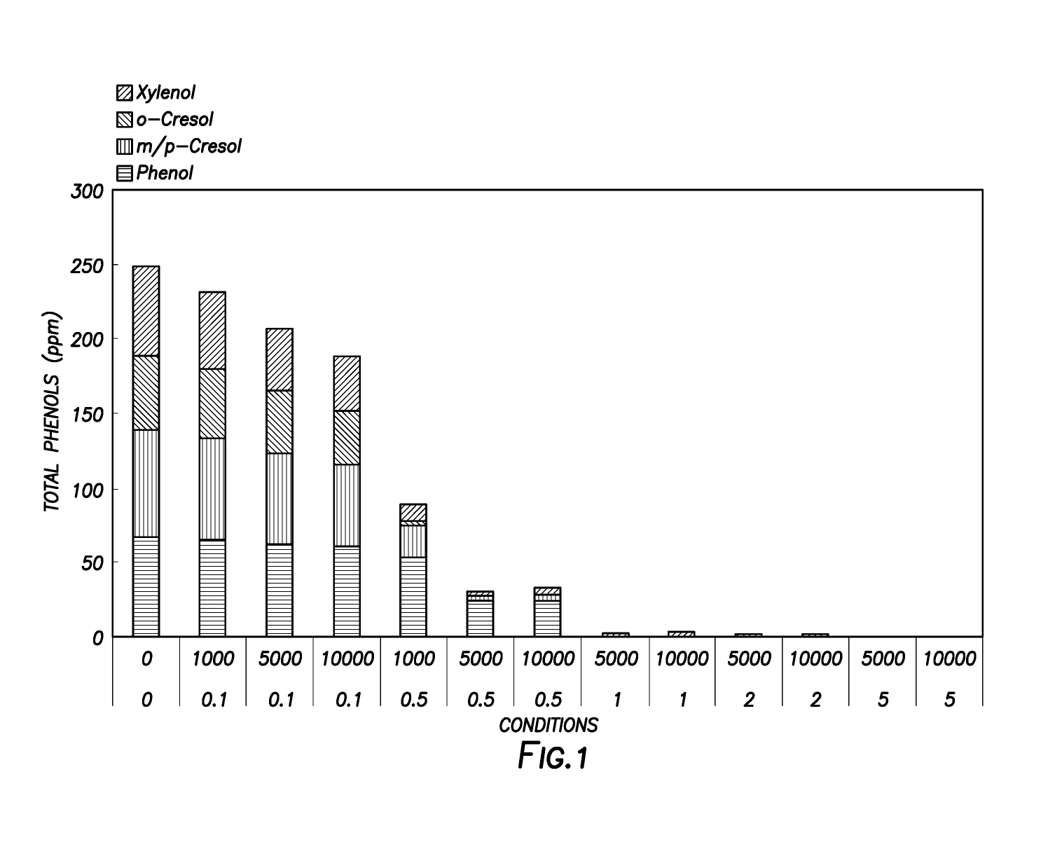

Jar tests were done with contaminated groundwater. 125 mL jars were charged with 50.0±0.5 g of contaminated soil. 50 mL of contaminated groundwater was then added to the jar. Dosages of iron tetra-amido macrocyclic solution from a stock solution were then injected into the 1:1 slurry via a pipette. Subsequently, a dosage of hydrogen peroxide from a 30% stock was injected into the jar. The jar was then capped, placed in a shaker, and allowed to shake in a circular motion at ˜200 rpm for 1 hour. After 1 hour, the shaker was stopped and the soil was allowed to settle for ˜5 min. After 5 min, sample was removed from the jar and placed in a centrifuge. The sample was centrifuged at ˜25,000 rpm for ˜15 min. After centrifuging, the supernatant was collected with a syringe and filtered using a 0.45 um teflon filter. FIG. 1 depicts the amount of phenols removed after analyzing the samples. Table 1 depicts the amount remediated after 1 week of run time.

TABLE 1

| | | | | HPLC | |
|---|---|---|---|---|---|
| | | HPLC | | Phenols | GC-MS |
| Fe-TAML | | Phenols | GC-MS | (PPM) After | (PPM) After |
| (ppm) | H2O2 (ppm) | (PPM) | (PPM) | 1 week | 1 week |
| 0 | 0 | 249.00 | 190.8 | | |
| 0.1 | 1000 | 231.00 | 200.2 | 231.93 | 227.00 |
| 0.1 | 1000 | 232.00 | 257.5 | 233.52 | 213.50 |
| 0.1 | 5000 | 207.00 | 194.6 | 208.96 | 161.80 |
| 0.1 | 10000 | 189.00 | 149.6 | 188.71 | 156.90 |
| 0.5 | 1000 | 90.00 | 102.6 | 86.38 | 67.55 |
| 0.5 | 5000 | 31.00 | 23.7 | 30.48 | 24.40 |
| 0.5 | 5000 | 41.00 | 31.7 | 39.25 | 32.00 |
| 0.5 | 10000 | 34.00 | 28.1 | 29.95 | 29.95 |
| 5 | 1000 | 14.00 | 11.8 | 13.59 | 13.59 |
| 5 | 5000 | 0.32 | 0 | 1.61 | 2.00 |
| 5 | 10000 | 0.33 | 0 | 1.72 | 1.72 |

### Test 2:

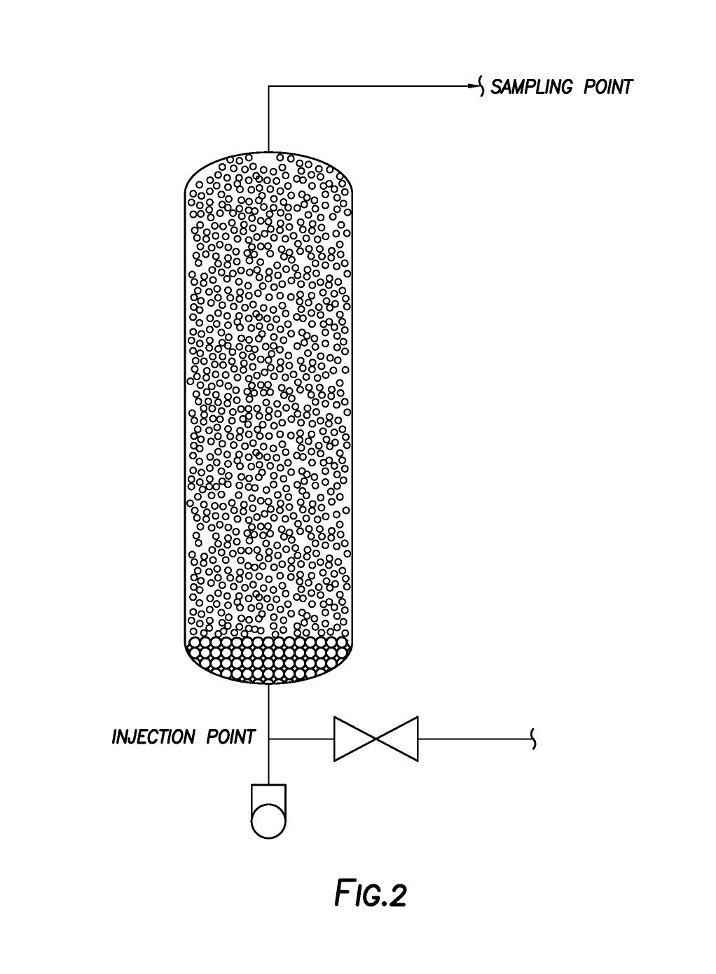

Flow system tests were done with a flow system design as shown in FIG. 2. A 25 cm×1.905 cm stainless steel reactor with 0.45 um frits or screens at both ends was utilized. Garnite particles of 2 mm size that were previously washed with 18 Mohm water are placed in the bottom of the reactor to simulate the gravel around the injection well bore. The gravel packing is ˜½ foot of the 12½ foot of radius that the treatment is supposed to cover. Therefore, when scaled linearly, the garnite packing is ˜1 cm in depth. A slurry of soil with contaminated groundwater was poured into the reactor. Additional contaminated groundwater was added to the reactor so as to wet the soil being introduced into the column, thus filling the reactor. The reactor was vigorously agitated so as to effectively pack the column at ˜20% porosity (porosity meaning that only 20% of the volume in the reactor is due to contaminated water). The column was then oriented as such that the influent to the reactor passed through the garnite particles first. A septum (injection point) and two-way valve were connected to the bottom of the reactor. Contaminated groundwater was then passed through the column at a rate of 10 mL/hour for at least 4 hours—most often overnight. Fine particles, below that of the filter size, were ejected from the column (this particle size was independently determined to account for less than 0.5% of the total soil mass). After a given period of equilibration with the contaminated influent, the influent was stopped and the two-way valve was closed. The dosage for a given treatment was then injected into the bottom of the column, making sure that the needle injected treatment into the garnite and/or soil. The injection proceeded by first dosing the column with iron tetra-amido macrocyclic solution and then with 30% hydrogen peroxide. The reaction between the two injections was allowed to proceed undisturbed for 1 hour. After 1 hour, influent flow was established with contaminated groundwater. Samples were then collected on the effluent line every 15 or 30 min.

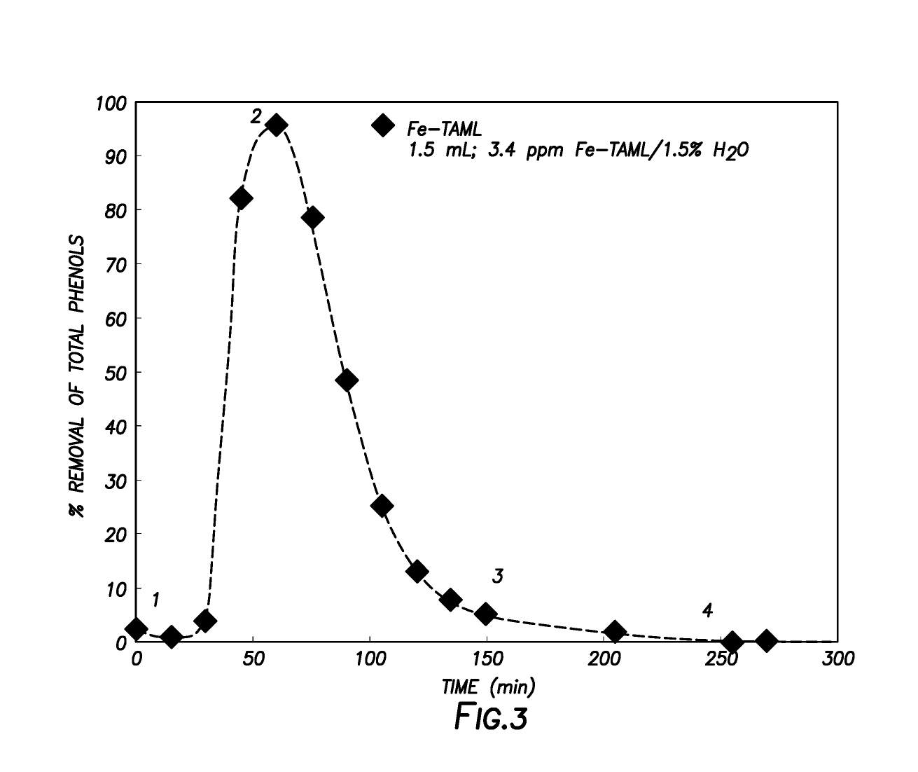

FIG. 3 depicts the flow system test using a total volume of injection of 1.5 mL wherein the injection method contains 3.4 ppm iron tetra-amido macrocyclic solution with 1.5% hydrogen peroxide. At timepoint 1 the contaminated water is moving through the column as a plug. Timepoint 2 depicts the removal of the phenols. Timepoint 3 depicts when the contaminated water has left the reactor and the clean water that was being passed through the column starts the desorb phenols from the soil. Timepoint 4 is when the influent contaminated groundwater has recharged the reactor to the point where the treated water has left the column and there is no removal of phenols. The area under this profile should equal the amount of phenols that can be extracted from the soil, giving a rough total mass of phenols in the reactor. As shown in the figure the total amount removed is 2.42 mg or 62% phenol removal.

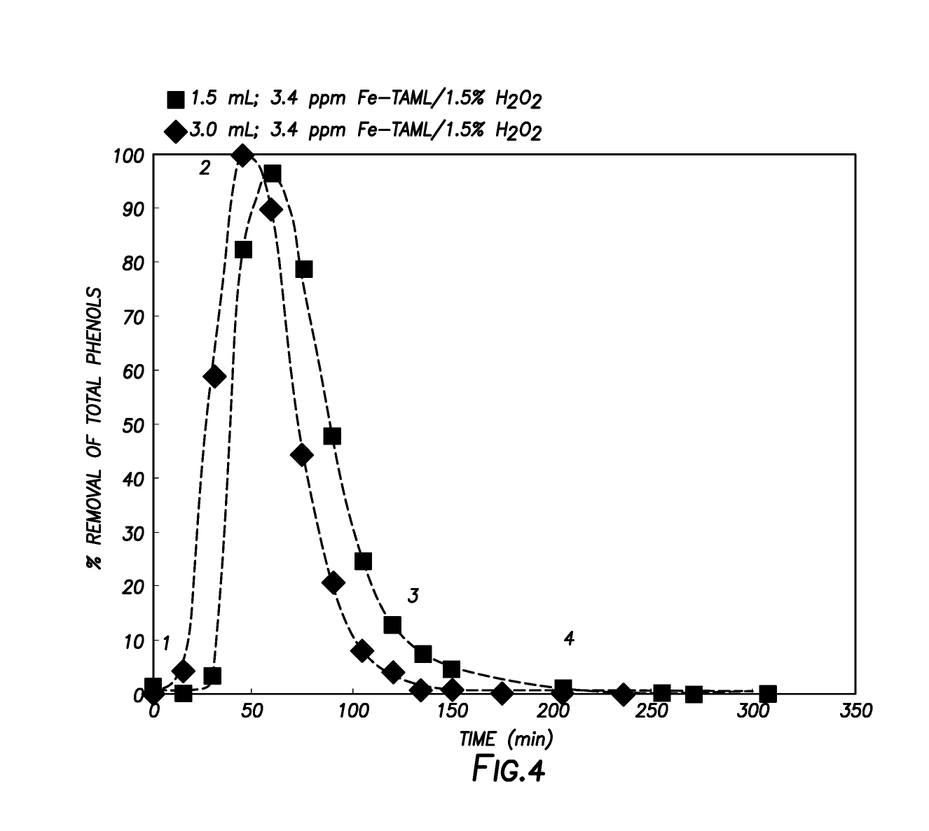

FIG. 4 depicts the flow system test comparing a total volume of injection of 1.5 ml with 3.0 ml wherein the injection method contains 3.4 ppm iron tetra-amido macrocyclic solution with 1.5% hydrogen peroxide. At timepoint 1 the contaminated water is moving through the column as a plug. Timepoint 2 depicts the removal of the phenols. Timepoint 3 depicts when the contaminated water has left the reactor and the clean water that was being passed through the column starts the desorb phenols from the soil. Timepoint 4 is when the influent contaminated groundwater has recharged the reactor to the point where the treated water has left the column and there is no removal of phenols. The area under this profile should equal the amount of phenols that can be extracted from the soil, giving a rough total mass of phenols in the reactor. As shown in the figure doubling the injection volume lowers the amount of phenol removed to 58% as compared to 62%.

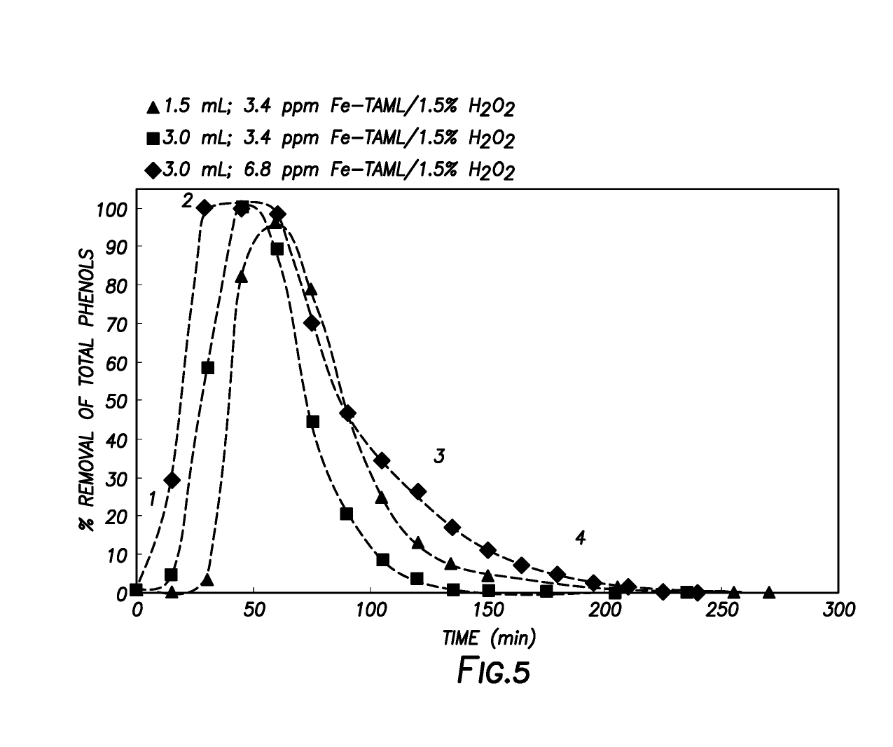

FIG. 5 depicts the flow system test comparing the ppm of the injection of the injection method 3.4 ppm iron tetra-amido macrocyclic solution with 1.5% hydrogen peroxide to 6.8 ppm iron tetra-amido macrocyclic solution with 3.4% hydrogen peroxide. At timepoint 1 the contaminated water is moving through the column as a plug. Timepoint 2 depicts the removal of the phenols. Timepoint 3 depicts when the contaminated water has left the reactor and the clean water that was being passed through the column starts the desorb phenols from the soil. Timepoint 4 is when the influent contaminated groundwater has recharged the reactor to the point where the treated water has left the column and there is no removal of phenols. The area under this profile should equal the amount of phenols that can be extracted from the soil, giving a rough total mass of phenols in the reactor. As shown in the figure increasing the injection volume and concentration the injection volume increases the amount of phenol removed to 85% as compared to 58%.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method of remediating groundwater comprising:
injecting a first aqueous solution of an iron ligand into a well situated within the area of the groundwater to be remediated; and
injecting a second aqueous solution of an oxidizing agent into the well,
wherein the ppm ratio of iron ligand solution to oxidizing agent ranges from about 0.0005 to about 0.1.

2. The method of claim 1, wherein the iron ligand is a tetra-amido macrocyclic ligand.

3. The method of claim 1, wherein the oxidizing agent is hydrogen peroxide.

4. The method of claim 1, wherein the well is situated at a depth greater than 25 feet below the surface.

5. The method of claim 1, wherein the well is situated at a depth greater than 50 feet below the surface.

6. The method of claim 1, wherein the well is situated at a depth greater than 100 feet below the surface.

7. The method of claim 1, wherein an injection of water occurs prior to the injection of the first aqueous solution.

8. The method of claim 1, wherein an injection of water occurs prior to the injection of the second aqueous solution and after the injection of the first aqueous solution.

9. The method of claim 1, wherein an injection of water occurs after the injection of the second aqueous solution.

10. The method of claim 1, wherein the volume ratio of the injection of iron ligand to oxidizing agent is form about 0.75 to about 1.25:1.

11. The method of claim 1, wherein the ppm ratio of iron ligand to oxidizing agent ranges from about 0.0001 to about 0.05.

12. The method of claim 1, wherein the volume of the first aqueous solution injected into the well ranges from about 800 gallons to about 1,200 gallons.

13. The method of claim 1, wherein the treated area within the groundwater is greater than 10 feet in height and a radius greater than 8 feet wide.

14. The method of claim 1, wherein the treated area within the groundwater is greater than 15 feet in height and a radius greater than 12.5 feet wide.

15. The method of claim 1, wherein the method remediates greater than 99% of the phenol in the groundwater.

16. A method of remediating contaminated groundwater consisting essentially of:
injecting a first aqueous solution of iron tetra-amido macrocyclic ligand into a well,
wherein the well is situated within the area of the groundwater to be remediated; and
injecting a second aqueous solution of hydrogen peroxide into the well.

17. A method of remediating groundwater comprising:
administering a first series of injections into a well comprising:
a first aqueous solution of aqueous iron tetra-amido macrocyclic ligand; and
a second aqueous solution of aqueous hydrogen peroxide solution,
wherein the ppm ratio of iron tetra-amido macrocyclic to hydrogen peroxide solution ranges from about 0.0005 to about 0.1
administering a second series of injections into the well comprising:
an aqueous remediating solution different than the first series of injections.
